(19) United States
(12) Patent Application Publication
(10) Pub. No.: US 2016/0332371 A1
(43) Pub. Date: Nov. 17, 2016

(54) ADDITIVE MANUFACTURING SYSTEM AND METHOD OF OPERATION

(71) Applicant: UNITED TECHNOLOGIES CORPORATION, Hartford, CT (US)

(72) Inventors: Alexander Staroselsky, Avon, CT (US); Thomas N. Slavens, Moodus, CT (US); Sergey Mironets, Charlotte, NC (US); Thomas J. Martin, East Hampton, CT (US); Brooks E. Snyder, Dartmouth (CA)

(21) Appl. No.: 15/112,020

(22) PCT Filed: Jan. 15, 2015
(86) PCT No.: PCT/US2015/011622

§ 371 Date: Jul. 15, 2016

Related U.S. Application Data
(60) Provisional application No. 61/930,252, filed on Jan. 22, 2014.

(51) Int. Cl. B29C 67/00; B33Y 30/00; B33Y 10/00; B23K 26/342; B23K 26/70

(52) U.S. Cl. CPC B29C 67/0077; B23K 26/342; B23K 26/702; B33Y 10/00; B33Y 30/00

(57) ABSTRACT

An additive manufacturing system and method of operation includes a build table for supporting a powder bed that is packed through the use of a vibration inducing device proximate to the build table. Through this packing, voids of the bed produced by larger particles of a mixed powder are filled with smaller particles. After or during such packing of particles, the powder bed is leveled utilizing a leveling arm, then selected regions of the bed are melted utilizing an energy gun.

This application claims priority to U.S. Patent Appln. No. 61/930,252 filed Jan. 22, 2014.

### BACKGROUND

The present disclosure relates to an additive manufacturing system and, more particularly, to a vibration inducing device of the system for packing a powder bed, and method of operation.

Traditional additive manufacturing systems include, for example, Additive Layer Manufacturing (ALM) devices, such as Direct Metal Laser Sintering (DMLS), Selective Laser Melting (SLM), Laser Beam Melting (LBM) and Electron Beam Melting (EBM) that provide for the fabrication of complex metal, alloy, polymer, ceramic and composite structures by the freeform construction of the work product, layer-by-layer. The principle behind additive manufacturing processes involves the selective melting of atomized precursor powder beds by a directed energy source, producing the lithographic build-up of the work product. The melting of the powder occurs in a small localized region of the energy beam, producing small volumes of melting, called melt pools, followed by rapid solidification, allowing for very precise control of the solidification process in the layer-by-layer fabrication of the work product. These devices are directed by three-dimensional geometry solid models developed in Computer Aided Design (CAD) software systems.

Significant effort is needed to improve the speed of ALM processes so that they can become a cost effective option to castings, and to improve the quality because ALM produced work products suffer from several deficiencies resulting in poor material characteristics, such as porosity, melt ball formations, layer delamination, and uncontrolled surface coarseness and material compositions.

### SUMMARY

An additive manufacturing system according to one, non-limiting, embodiment of the present disclosure includes a powder bed including a mixed powder, and a first vibration inducing device in communication with the powder bed for packing the mixed powder.

Additionally to the foregoing embodiment, the first vibration inducing device is a sonic emitter.

In the alternative or additionally thereto, in the foregoing embodiment, the system further includes a build table supporting the powder bed.

In the alternative or additionally thereto, in the foregoing embodiment, the first vibration inducing device is secured to the build table.

In the alternative or additionally thereto, in the foregoing embodiment, the system includes the build table having a substantially horizontal plate, a first sidewall, and an opposing second sidewall projecting upward from the plate, and a second vibration inducing device secured to the second sidewall, and the first vibration inducing device being secured to the first side wall.

In the alternative or additionally thereto, in the foregoing embodiment, the first and second vibration inducing devices are sonic emitters.

In the alternative or additionally thereto, in the foregoing embodiment the first sidewall is disposed between the powder bed and the first vibration inducing device and the second sidewall is disposed between the powder bed and the second vibration inducing device.

In the alternative or additionally thereto, in the foregoing embodiment, the system includes a leveling arm constructed and arranged to level the powder bed.

In the alternative or additionally thereto, in the foregoing embodiment the build table is constructed and arranged to move in a z-coordinate direction and the leveling arm moves in an x-coordinate direction.

In the alternative or additionally thereto, in the foregoing embodiment, the first and second sidewalls are spaced from one another in the x-coordinate direction.

In the alternative or additionally thereto, in the foregoing embodiment, the first and second vibration inducing devices are ultrasonic emitters producing opposing ultrasonic waves through the powder bed.

In the alternative or additionally thereto, in the foregoing embodiment, the system includes a spreader for distributing the mixed powder on the build table, and an energy gun for selectively melting the powder bed.

In the alternative or additionally thereto, in the foregoing embodiment the vibration inducing device is in the powder bed.

In the alternative or additionally thereto, in the foregoing embodiment the vibration inducing device is integral to the leveling arm and the leveling arm is a roller.

A method of operating an additive manufacturing system according to another, non-limiting, embodiment includes the steps of sending vibration waves through a powder bed, and compacting the powder bed by moving small particles of the powder bed into voids created by large particles of the powder bed via the vibration waves.

Additionally to the foregoing embodiment, the method includes the further step of leveling the powder bed.

In the alternative or additionally thereto, in the foregoing embodiment a roller is used to level the powder bed.

In the alternative or additionally thereto, in the foregoing embodiment the vibration waves are emitted by the roller and the powder bed is compacted at the same time the powder bed is leveled.

In the alternative or additionally thereto, in the foregoing embodiment, the method includes compacting the powder bed before leveling, moving a build table downward by generally a layer thickness of a work product, repeating the steps for a next successive layer, and wherein the work product is a turbine blade.

In the alternative or additionally thereto, in the foregoing embodiment, the method includes sending second vibration waves that oppose the vibration waves through the powder bed.

The foregoing features and elements may be combined in various combinations without exclusivity, unless expressly indicated otherwise. These features and elements as well as the operation thereof will become more apparent in-light of the following description and the accompanying drawings. It should be understood, however, the following description and figures are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic view of an additive manufacturing system according to one non-limiting embodiment of the present disclosure;

FIG. 2 is a plan view of a build table of the additive manufacturing system;

FIG. 3 is a cross section of the build table taken along line 3-3 of FIG. 2;

FIG. 4 is a cross section of a work product of the additive manufacturing system;

FIG. 5 is an operation flow chart;

FIG. 6 is a second non-limiting embodiment of a build table; and

FIG. 7 is a cross section of the build table taken along line 7-7 of FIG. 6.

### DETAILED DESCRIPTION

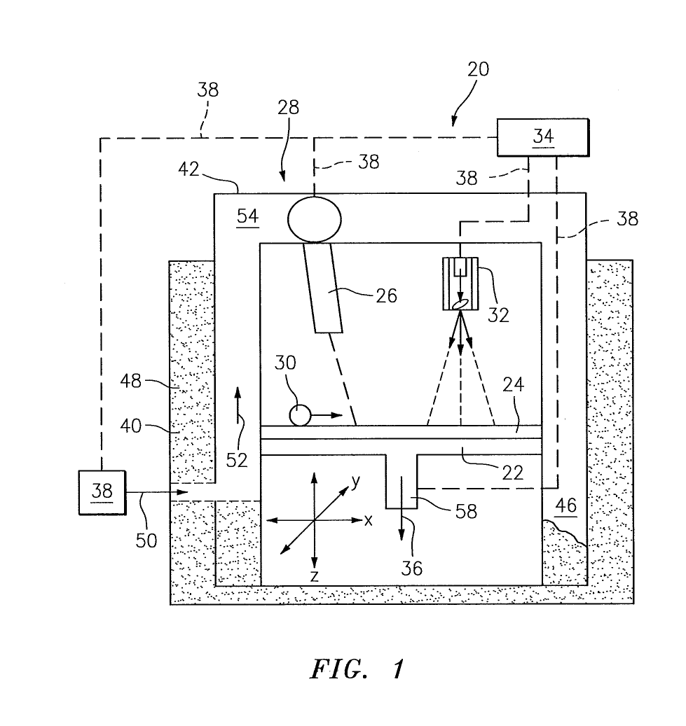

FIG. 1 schematically illustrates an additive manufacturing system 20 that may have a build table 22 for holding a powder bed 24, a particle spreader 26 for producing the powder bed 24, a powder feed apparatus 28 for controllably supplying powder to the spreader 26, a spreader arm 30 for leveling the powder bed, an energy gun 32 for selectively melting regions of the powder bed, and a controller 34 for controlling the various operations of the components. The system 20 is constructed to build a work product (for example a turbine blade, see FIG. 6) in a layer-by-layer process. The build table 22 is thus constructed to move along a substantially vertical z-coordinate, as generally illustrated by arrow 36. As each layer of the work product is formed, the build table 22 receives an electric signal 38 from the controller 34 and moves downward by a distance that is substantially equal to the height of the next layer. The powder bed 24 is generally formed or produced by the particle spreader or nozzle 26 for each layer. The spreader 26 may be a traversing X-Y coordinate gantry spreader and may receive the mixed powder from the feed device 28. Generally, the powder bed 24 is formed across the entire build table 22 at a substantially consistent thickness and may have a powder composition that may be achieved by the feed apparatus 28 through a series of control valves (not shown) controlled by the controller 34 through the electric signals 38.

The powder feed apparatus 28 may be capable of distributing specific particle sizes of a mixed powder upon the build table 22, and may have an air supply device 38, a supply hopper 40, a housing 42, a plurality of offtake conduits associated with the series of control valves (not shown) and a feed return hopper 46. The air supply device 38 may be an air compressor located in an upstream direction from the supply hopper 40. The hopper 40 contains a mixed powder 48 and is capable of feeding the powder 48 into an airstream (see arrow 50) produced by the air supply device 38. The combined air and powder mixture (see arrow 52) may flow through a passage 54 defined by the housing 42. It is understood and contemplated that the hopper 40 may be any means of supplying a mixed powder into the airflow and may include a piston actuated type device (not shown). It is further understood and contemplated that the air supply device 38 may be any device capable of pushing or pulling air through the housing 42 for suspending the powder in the airflow.

Alternatively, the powder feed apparatus 28 of the additive manufacturing system 20 may not need to separate particles of the powder into specific sizes, and thus may not require suspension of the particles in an airstream. Instead, the mixed powder may be fed directly onto the build table 22 from the supply hopper 40 via gravity, or a mechanical device, and then spread across the build table utilizing the spreader arm 30. The arm 30 may be a rake, a roller or other device capable of leveling the powder bed 24. In this, non-limiting, example a mixed powder having disparate particle sizes and/or mixed materials may be procured as such from a supplier and fed directly into the hopper 40 for direct distribution upon the build table 22.

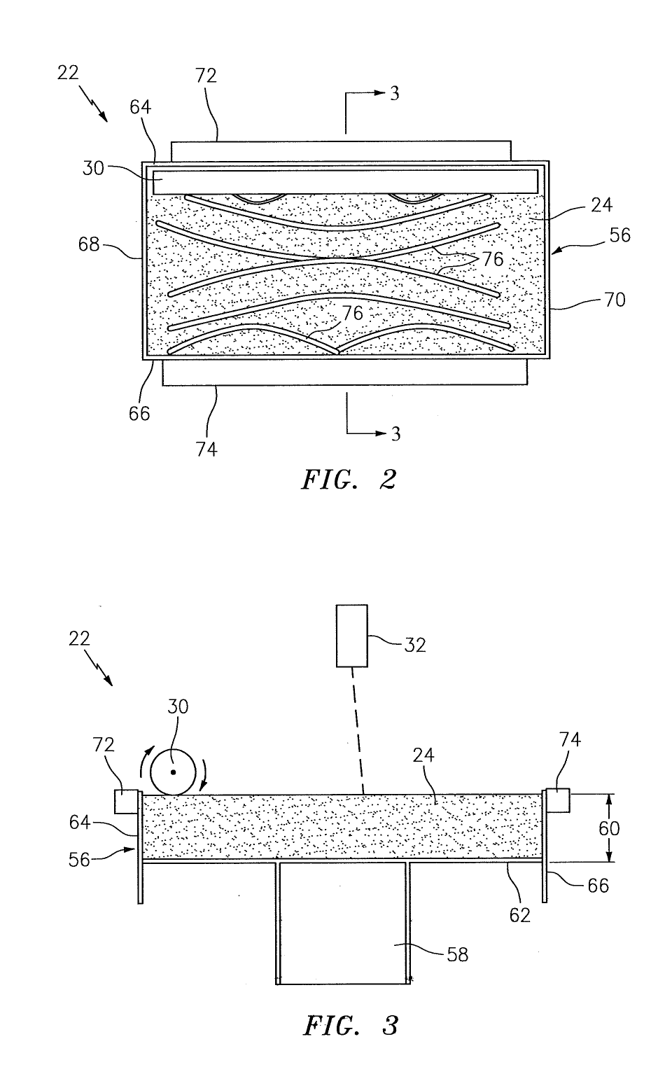

Referring to FIGS. 2 and 3, the build table 22 may include a tray 56 that supports the powder bed 24 and a drive mechanism 58 capable of incrementally lowering the tray 56 in a vertical (i.e. z-coordinate direction 36) by a distance about equal to a thickness 60 of each layer of the build. The tray 56 may be substantially orthogonal and may include a bottom plate 62 disposed substantially horizontal (i.e. lying within an x-y coordinate plane) and four sidewalls 64, 66, 68, 70 projecting upward from plate 62. Sidewalls 64, 66 generally oppose one-another on opposite sides of the plate 62 and generally extend in the x-coordinate direction. Similarly, sidewalls 68, 70 oppose one-another, but extend about in the y-coordinate direction.

Vibration inducing devices 72, 74 may be secured to an exterior side of respective sidewalls 64, 66. Each device 72, 74 substantially extends along the entire length of each sidewall 64, 66 for the even distribution of vibration waves 76 generally through the tray 56 and into the powder bed 24. As one non-limiting example, the vibration inducing devices 72, 74 may be ultrasonic emitters that produce ultrasonic vibration waves. The waves 76 act to force the smaller particles of the powder bed 24 into voids created by larger particles. The electrical power needed to move a particle using this method can be calculated (as an example) utilizing about a 1 k Watt source with about a 1 mm particle size that travels about 10 e-10 meters with the time for travel at about 10 e-4 seconds. That is, with a 1 k Watt source, the particle will travel a distance about equal to it's diameter of about 1 mm in about 0.1 seconds. As a further example, and to move this distance for a smaller particle size of about 0.5 mm, the required power drops to about 500 Watts that is well within the power output of a typical ultrasonic emitter.

More specifically with regard to power, and assuming a spherical power source or device 72 as one example, the power (P) of the source is related to the pressure (p) at the location of the particle to be moved. The relevant equation is:

P=(2πr²)(p²/πₘc) (1)

Where (r) is the distance from the source to the particle to be moved, (ρₘ) is the media or powder density and (c) is the wave speed. The pressure (p) should be sufficient to move a particle to the distance of the order of half of the particle diameter. The relative equation is:

mz″=force=(pπd²)/4 (2)

Where (m) is the mass of the particle, and (z) is the desired particle displacement. With the mass (m) of the particle equal to:

m=(πd³πₚ)/6

where (ρₚ) is the particle density and substituting the mass (m) into equation (2) and assuming z(f) =d/2, the pressure required to move a particle is about:

p=(2/3)(ρₚd²υ²)/(n²) (3)

where (υ) is the wave frequency and (n) is the number of wave pulses needed to move the particle during the time t:

t=n/υ (4)

Thus the estimation for required power (P) of the source may be determined by equation:

P=(2πr²)(4/9)(ρₚ²d⁴υ⁴)/(n⁴ρₘc)≈(πr²ρₚd⁴υ⁴)/(cλ)

Therefore, to determine desired power (P) of the device 72 or device 74 the following parameters may be established as one, non-limiting, example:

r=0.1 m

d=3(10⁻⁵) m

ρₚ=10⁴ kg/m³

c=3(10³) m/s

υ≈50 to 100 kHz

λ=ρ_{media}/ρ_{particle}≈0.1

Thus power (P) under the above given parameters is calculated to be about 100 to 500 watts. It is therefore estimated that about one device 72 at about 100 watts power is sufficient to pack the powder with the above given parameters as one example.

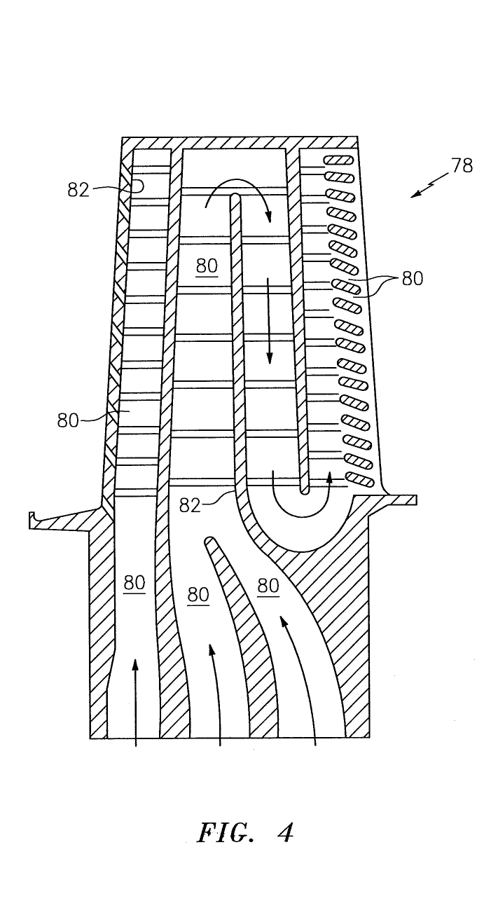

Referring to FIG. 4 an example of a work product produced by the novel, non-limiting embodiment of the additive manufacturing system 20. In this example, the work product is a turbine blade 78 for a gas turbine engine. Turbine engine components such as that found in a turbine section often operate at temperatures that exceed the melting point of the component constituent materials. Due to this, dedicated cooling air is extracted from the compressor of the engine and used to cool the gas path components in the engine incurring significant cycle penalties especially when cooling is utilized in the low pressure turbine. To enhance durability of the turbine blade 78, intricate interior cooling channels 80, defined by intricate interior surfaces 82, are employed. For ever higher effective efficiencies, interior cooling features must get smaller and more complicated to augment the interior heat transfer coefficients. More traditional casting techniques are not capable of producing such interior detail. System 20 that utilizes the vibration inducing devices 72, 74 is able to reduce material voids and porosity common in more traditional additive manufacturing systems, and is thus capable of producing (for example) the intricate interior surfaces 82 of the blade 78 allowing for high fidelity resolution of small features.

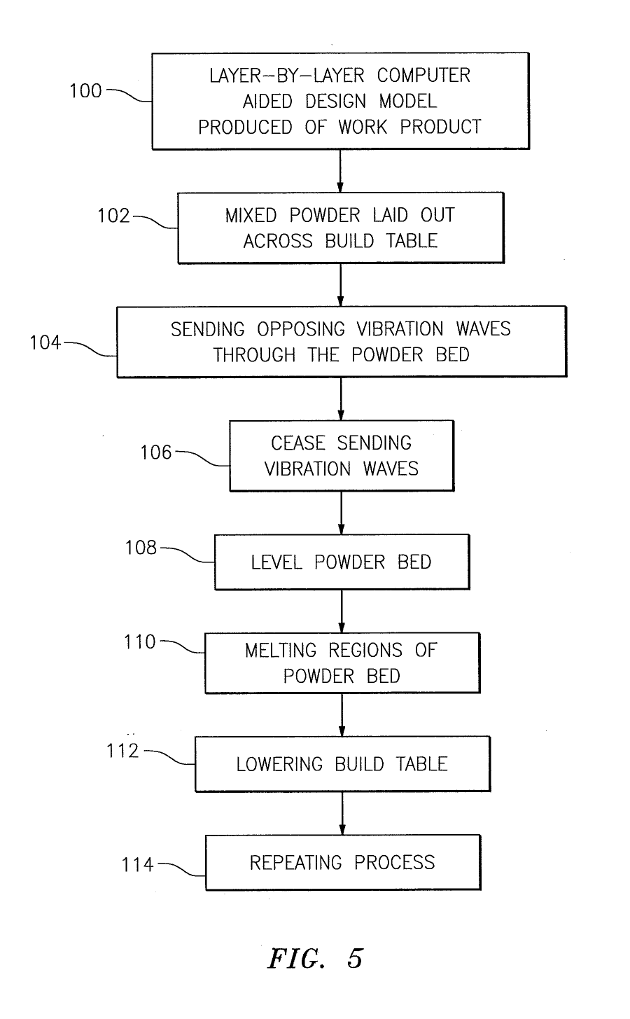

Referring to FIG. 5 and as a first step 100 of operation, a three-dimensional geometry of the turbine blade 78 (for example) may be designed in a Computer Aided Design (CAD) software system of, or loaded into, the controller 34. This design includes pre-specified patterns of the turbine blade 78 on a layer-by-layer basis such that surface detail can be controlled (e.g. minimizing voids and porosity). To fabricate the turbine blade 78 and as a next step 102, the mixed powder 48 is laid out across the tray 56 of the build table 22 by the spreader 26 and as dictated via electric signals 38 received from the controller 34. As step 104, the vibration inducing devices 72, 74 are energized sending vibration waves through the powder bed 24 that results in the smaller particles filling the voids produced by the larger particles. This may be performed at a pre-set power and time duration controlled by the controller 34. As step 106, the controller 34 deactivates the vibration inducing devices 72, 74, and as step 108, activates the leveling arm 30 that moves across the tray 56 and thereby levels the bed 24 and deposits excess powder in the feed return hopper 46. Once leveled by the arm 30 and as a step 110, the energy gun 32 receives a signal 38 from the controller 34 and melts the powder bed 24 at pre-specified regions thereby producing a solidified layer of the turbine blade 78. As step 112, the drive mechanism 58 of the build table 22 moves the tray 56 downward by an approximate distance 60 and, as step 114, the process repeats itself. It is reaffirmed and understood that the work product is not limited to a turbine blade, but may include any article of manufacture that, for example, may have fine details that are sensitive toward voids and porosity characteristics.

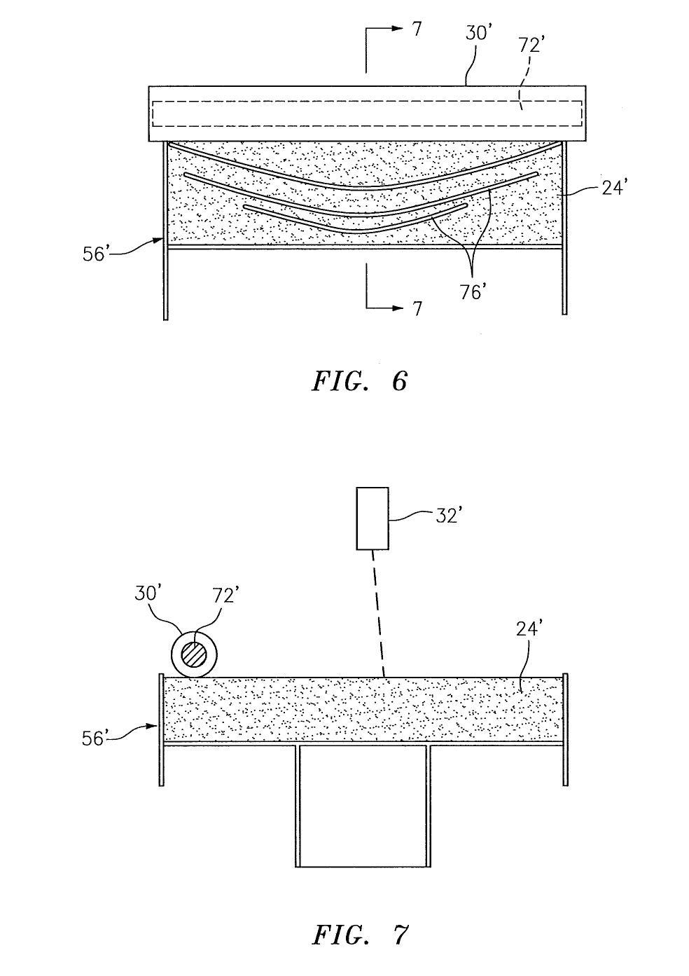

Referring to FIGS. 6 and 7, another non-limiting embodiment of the present disclosure is illustrated wherein like elements to the first embodiment have like identifying numerals except with the addition of a prime symbol. Here, the vibration inducing device 72′ is integral to the leveling arm 30′ and are not directly secured to the tray. In this embodiment, the leveling action of the arm 30′ and the particle packing function of the device 72′ is performed as one operation step. The vibration waves 76′ are sent downward into the powder bed 24, and the powder bed thus receives a substantially even distribution of vibration waves after the arm 30′ completes the leveling sweep. It is further understood and contemplated that the vibration inducing devices may be placed directly into the powder bed, and not necessarily connected directly to the arm of sidewalls of the tray.

It is understood that relative positional terms such as “forward,” “aft,” “upper,” “lower,” “above,” “below,” and the like are with reference to the normal operational attitude and should not be considered otherwise limiting. It is also understood that like reference numerals identify corresponding or similar elements throughout the several drawings. It should be understood that although a particular component arrangement is disclosed in the illustrated embodiment, other arrangements will also benefit. Although particular step sequences may be shown, described, and claimed, it is understood that steps may be performed in any order, separated or combined unless otherwise indicated and will still benefit from the present disclosure.

The foregoing description is exemplary rather than defined by the limitations described. Various non-limiting embodiments are disclosed; however, one of ordinary skill in the art would recognize that various modifications and variations in light of the above teachings will fall within the scope of the appended claims. It is therefore understood that within the scope of the appended claims, the disclosure may be practiced other than as specifically described. For this reason, the appended claims should be studied to determine true scope and content.

What is claimed is:

1. An additive manufacturing system comprising:
a powder bed including a mixed powder; and
a first vibration inducing device in communication with the powder bed for packing the mixed powder.

2. The additive manufacturing system set forth in claim 1 wherein the first vibration inducing device is a sonic emitter.

3. The additive manufacturing system set forth in claim 1 further comprising:
a build table supporting the powder bed.

4. The additive manufacturing system set forth in claim 3 wherein the first vibration inducing device is secured to the build table.

5. The additive manufacturing system set forth in claim 4 further comprising:
the build table including a substantially horizontal plate, a first sidewall, and an opposing second sidewall projecting upward from the plate; and
a second vibration inducing device secured to the second sidewall, and the first vibration inducing device being secured to the first side wall.

6. The additive manufacturing system set forth in claim 5 wherein the first and second vibration inducing devices are sonic emitters.

7. The additive manufacturing system set forth in claim 5 wherein the first sidewall is disposed between the powder bed and the first vibration inducing device and the second sidewall is disposed between the powder bed and the second vibration inducing device.

8. The additive manufacturing system set forth in claim 3 further comprising:
a leveling arm constructed and arranged to level the powder bed.

9. The additive manufacturing system set forth in claim 8 wherein the build table is constructed and arranged to move in a z-coordinate direction and the leveling arm moves in an x-coordinate direction.

10. The additive manufacturing system set forth in claim 9 wherein the first and second sidewalls are spaced from one another in the x-coordinate direction.

11. The additive manufacturing system set forth in claim 10 wherein the first and second vibration inducing devices are ultrasonic emitters producing opposing ultrasonic waves through the powder bed.

12. The additive manufacturing system set forth in claim 3 further comprising:
a spreader for distributing the mixed powder on the build table; and
an energy gun for selectively melting the powder bed.

13. The additive manufacturing system set forth in claim 1 wherein the vibration inducing device is in the powder bed.

14. The additive manufacturing system set forth in claim 8 wherein the vibration inducing device is integral to the leveling aim and the leveling arm is a roller.

15. A method of operating an additive manufacturing system comprising the steps of:
sending vibration waves through a powder bed; and
compacting the powder bed by moving small particles of the powder bed into voids created by large particles of the powder bed via the vibration waves.

16. The method set forth in claim 15 comprising the further step of:
leveling the powder bed.

17. The method set forth in claim 16 wherein a roller is used to level the powder bed.

18. The method set forth in claim 17 wherein the vibration waves are emitted by the roller and the powder bed is compacted at the same time the powder bed is leveled.

19. The method set forth in claim 16 comprising the further steps of:
compacting the powder bed before leveling;
moving a build table downward by generally a layer thickness of a work product;
repeating the steps for a next successive layer; and
wherein the work product is a turbine blade.

20. The method set forth in claim 15 further comprising the step of:
sending second vibration waves that oppose the vibration waves through the powder bed.
